(19) United States
(12) Patent Application Publication
(10) Pub. No.: US 2016/0362548 A1
(43) Pub. Date: Dec. 15, 2016

(54) Polycarbonate Composition and Preparation Method Thereof

(71) Applicant: Kingfa Scientific & Technological Co., LTD., Guangzhou (CN)

(72) Inventors: Guo Tanghua, GuangzhouScience (CN); Cen Yin, Guangzhou (CN); Tong Wei, Guangzhou (CN); Ai Junwei, Guangzhou (CN); Li Mingkun, Guangzhou (CN); He Jihun, Guangzhou (CN); Sun Donghai, Guangzhou (CN)

(21) Appl. No.: 15/050,848

(22) Filed: Feb. 23, 2016

(30) Foreign Application Priority Data
Jun. 9, 2015 (CN) 201510310060.8

(51) Int. Cl. C08L 69/00; C08L 55/02

(52) U.S. Cl. CPC C08L 69/00; C08L 55/02

(57) ABSTRACT

The present invention discloses a polycarbonate composition, which includes the following components in parts by weight:
a. 30-80 parts of a polycarbonate;
b. 8-50 parts of a graft copolymer;
c. 5-25 parts of a fire retardant; and
d. 0-10 parts of other aids;
   wherein a sum of parts by weight of the four components a, b, c, and d is 100. A long-term thermal-oxidative aging property and a weathering property of the polycarbonate composition can be significantly improved when a total compounding amount of a transition element and an alkaline earth metal, which are added in a polycarbonate composition formula, based on a total weight of the polycarbonate composition is greater than or equal to 10 ppm and less than or equal to 600 ppm and a compounding molar ratio of the transition element to the alkaline earth metal is adjusted to 0.1-1; and the polycarbonate composition is particularly suitable for occasions with relatively high requirements for an operating environment.

### TECHNICAL FIELD

The present invention relates to the technical field of engineering plastics, particularly relates to a polycarbonate composition and a preparation method thereof.

### BACKGROUND

Polycarbonate PC has properties such as relatively high impact resistance, heat resistance; and to improve its processability and overcome a disadvantage of being sensitive to a notch impact, rubber modified polymers such as ABS, MBS may generally be added. Particularly, a PC/ABS alloy having PC and ABS as main raw materials is an important engineering plastic, which may synthesize excellent properties of the both, thereby enhancing a physical property and the processability; however, various metal ions may be introduced due to addition of various aids and inorganic fillers, which may cause hidden troubles about long-term thermal-oxidative aging property and weathering property, particularly for occasions having a superior operating environment requirement.

Patent US 20130289177 A1 discloses a composition characterized by selectively using a low lithium-ion content and a specified sodium-ion and/or potassium-ion content which exceeds the lowest level and preferably does not exceed the highest level, which shows improved hydrolysis resistance, but does not mention other weathering properties.

Until now, no influences of a total compounding amount of a transition element and an alkaline earth metal and a compounding molar ratio of the transition element to the alkaline earth metal on the long-term thermal-oxidative aging property and the weathering property of the polycarbonate composition have been reported.

With a result of extensive experiments, the inventor surprisingly has found that, the long-term thermal-oxidative aging property and the weathering property of the polycarbonate composition can be significantly improved when the total compounding amount of the transition element and the alkaline earth metal, which are added in a polycarbonate composition formula, based on a total weight of the polycarbonate composition is greater than or equal to 10 ppm and less than or equal to 600 ppm and the compounding molar ratio of the transition element to the alkaline earth metal is adjusted to 0.1-1; and the polycarbonate composition is particularly suitable for occasions with relatively high requirements for an operating environment.

SUMMARY OF THE INVENTION

To overcome disadvantages and shortcomings of the prior art, a primary object of the present invention is to provide a polycarbonate composition having a good flowability, a high glossiness and a color stability before and after long-term thermal-oxidative aging.

Another object of the present invention is to provide a preparation method of the above-described polycarbonate composition.

The present invention is accomplished by the following technical solution:

a polycarbonate composition, which includes the following components in parts by weight:

a. 30-80 parts of a polycarbonate;

b. 8-50 parts of a graft copolymer;

c. 5-25 parts of a fire retardant; and

d. 0-10 parts of other aids;

wherein a sum of parts by weight of the four components a, b, c, and d is 100.

Preferably, a polycarbonate composition includes the following components in parts by weight:

a. 35-75 parts of a polycarbonate;

b. 8-35 parts of a graft copolymer;

c. 5-25 parts of a fire retardant; and

d. 0-10 parts of other aids;

wherein a sum of parts by weight of the four components a, b, c, and d is 100;

a total compounding amount of a transition element and an alkaline earth metal based on a total weight of the polycarbonate composition is greater than or equal to 10 ppm and less than or equal to 600 ppm, and a compounding molar ratio of the transition element to the alkaline earth metal is 0.1-1.

Wherein, a testing method of a content of the transition metal: ICP-MS standard mixture method.

A testing method of a content of the alkaline earth metal: CP-MS standard mixture method.

Preferably, the total compounding amount of the transition element and the alkaline earth metal based on the total weight of the polycarbonate composition is greater than or equal to 50 ppm and less than or equal to 500 ppm, further preferably greater than or equal to 70 ppm and less than or equal to 400 ppm,.

Preferably, the compounding molar ratio of the transition element to the alkaline earth metal is 0.2-0.8, preferably 0.3-0.6.

Wherein, the transition element s selected from Fe and/or Mn; and the alkaline earth metal is selected from Mg and/or Ca.

When the compounding molar ratio of the transition element to the alkaline earth metal is less than 0.1 or greater than 1, the polycarbonate composition is poor in flowability during processing, which causes a result that a product is easily susceptible to appearance defect, poor glossiness, and poor weathering property.

Wherein, the polycarbonate is selected from one or more of an aromatic polycarbonate, an aliphatic polycarbonate, an aromatic-aliphatic polycarbonate, a branched polycarbonate, and a siloxane copolycarbonate, preferably the aromatic polycarbonate.

Preferably, the aromatic polycarbonate is an aromatic polycarbonate with a viscosity-average molecular weight of 13000-40000, more preferably an aromatic polycarbonate with a viscosity-average molecular weight of 16000-28000. When the viscosity-average molecular weight is within the above-described range, a mechanical strength is superior, and an excellent moldability can be maintained. Wherein, the viscosity-average molecular weight is calculated by testing a viscosity of a solution at 25° C. by using dichloromethane as a solvent.

The above-described polycarbonate may be prepared by an interfacial polymerization method and an ester-interchange method, and a content of a terminal hydroxy group can be controlled in the process.

Wherein, the graft copolymer is selected from one or more of a graft copolymer prepared from an alkaline earth metal salt by using an emulsion polymerization method, a graft copolymer prepared from an alkaline earth metal salt by using a bulk polymerization method, and a graft copolymer prepared from an alkaline earth metal salt by using a hulk-suspension polymerization method, preferably the graft copolymer prepared from the alkaline earth metal salt by using the emulsion polymerization method.

The hulk polymerization method includes five steps: dissolving, prepolymerizing, polymerizing, devolatilizing and pelletizing, more particularly, dissolving a rubber in ethylbenzene and styrene; adding monomers in accordance with a formulation amount to prepare into a raw material solution, inputting the prepared raw material solution into a prepolymerizer to perform prepolymerization; during polymerizing, grafting the monomers to the rubber, copolymerizing the monomers at the same time, separating from the solution, forming a discontinuous phase dispersed in a continuous phase in the raw material solution, whereby after enough monomers are polymerized, a copolymer in the discontinuous phase becomes a continuous phase, and the grafted rubber forms a discontinuous phase, and the discontinuous phase is dispersed in the continuous copolymer phase, thereby accomplishing a phase transition; finally, performing further polymerization, vacuum degassing, extruding, cooling and pelletizing to obtain a final product.

The bulk-suspension polymerization method comprises: regulating a rubber and monomer solution in accordance with a formula, and adding a polymerization regulator and a radical initiator at the same time; performing hulk polymerization on a monomer mixture at 80° C.-120° C., continuously stifling during polymerizing, and adding deionized water and a suspending agent into the mixture to ensure that the mixture is dispersed; and then performing suspension polymerization by using a radical catalyst, performing coagulating, filtering, washing, dehydrating and drying after obtaining a certain polymerization degree, and then pelletizing to obtain products.

The emulsion polymerization method comprises: grafting a rubber by controlling a polymerization temperature at 50° C.-80° C., and adding a monomer mixture into a rubber latex in the presence of an initiator, deionized water, an emulsifier and a cross-linking agent, and finally pelletizing after performing washing, dehydrating and drying to obtain a product.

Wherein, the graft copolymer is selected from the following graft copolymers containing b.1 on b.2 in parts by weight:

b.1 5-95 parts of a mixture of b.1.1 and b.1.2:
b.1.1 50-95 parts of one or more of styrene, styrene derivatives such as α-methyl styrene, p-benzyl styrene, and divinyl styrene, C1-C8 alkyl methacrylate, C1-C8 alkyl acrylate, dimethyl siloxane, phenyl siloxane, and multi-alkyl siloxane;
b.1.2 5-50 parts of one or more of acrylonitrile, methyl acrylonitrile, C1-C8 alkyl methacrylate, and C1-C8 alkyl acrylate;

b.2 5-95 parts of one or more of polybutadiene, polyisoprene, a styrene-butadiene random copolymer and block copolymer, an acrylonitrile-butadiene random copolymer and block copolymer, a polybutadiene and polyisoprene copolymer, an ethylene and α-alkene copolymer, an ethylene and α-unsaturated carboxylate copolymer, an ethylene-propene-nonconjugated diene terpolymer, an acryloyl rubber, and an organic siloxane rubber.

More preferably, the graft copolymer is selected from one or more of an acrylonitrile-styrene copolymer AS, an acrylonitrile-butadiene-styrene graft copolymer ABS, a methyl methacrylate-acrylonitrile-butadiene-styrene copolymer MABS, an acrylonitrile-styrene-propenoic acid terpolymer ASA, and a methyl methacrylate-butadiene-styrene graft copolymer MBS; wherein, a particle diameter of the MBS is preferably 0.1 μm-0.5 μm, a particle diameter of the ABS in the bulk polymerization method is preferably 0.1 μm-2 μm, and a particle diameter of the ABS in the emulsion polymerization method is preferably 0.05 μm-0.2 μm.

The graft copolymer is further preferably the acrylonitrile-butadiene-styrene graft copolymer ABS, wherein a percentage by weight of a butadiene rubber polymer in the ABS is 5 wt %-50 wt %, a particle diameter distribution can be a uniform distribution or a multi-distribution with two or more peak values.

Wherein, the fire retardant is selected from a halogen-based fire retardant or a halogen-free fire retardant, preferably the halogen-free fire retardant; the halogen-based fire retardant is selected from one or more of a brominated polystyrene, a brominated polyphenyl ether, a brominated bisphenol A type epoxy resin, a brominated styrene-maleic anhydride copolymer, a brominated epoxy resin, a brominated phenoxy resin, decabromodiphenyl oxide, decabromodiphenyl, a brominated polycarbonate, perbromotricyclopentadecane or a brominated aromatic crosslinked polymer, preferably the brominated polystyrene; the halogen-free fire retardant is selected from one or more of a nitrogen-containing fire retardant, a phosphorus-containing fire retardant or a nitrogen- and phosphorus-containing fire retardant, preferably the phosphorus-containing fire retardant.

Preferably, the phosphorus-containing fire retardant is selected from one or more of triphenyl phosphate, tritolyl phosphate, tolyl diphenyl phosphate, trixylyl phosphate, tri(2,4,6-trimethyl phenyl) phosphate, tri(2,4-di-tert-butyl phenyl) phosphate, tri(2,6-di-tert-butyl phenyl) phosphate, resorcinol bis(diphenyl phosphate), hydroquinone bis(diphenyl phosphate), bisphenol A-bis(diphenyl phosphate), resorcinol bis(2,6-di-tert-butyl phenyl phosphate), and hydroquinone bis(2,6-dimethyl phenyl phosphate).

The polycarbonate composition may further contain other aids, for example, selected from one or more of a heat stabilizer, an antioxidant, an anti-dripping agent, a lubricant, a releasing agent, a light stabilizer, a plasticizer, a filler, and a colorant.

The suitable thermal stabilizer includes an organic phosphite such as triphenyl phosphite, tri(2,6-dimethyl phenyl) phosphite, and tri(nonyl phenyl) phosphite, dimethyl phenyl phosphonate, and trimethyl phosphate.

The suitable antioxidant includes an organic phosphite, an alkylated monophenol or polyphenol, an alkylated reaction product of a polyphenol and a diene, a butylated reaction product of p-cresol or dicyclopentadiene, alkylated hydroquinones, hydroxylated thiodiphenyl ethers, alkylene-bisphenol, benzyl compounds, and polyol esters.

The suitable anti-dripping agent is preferably selected from a fluorated polyolefin, the fluorated polyolefin is well known (referring to EP-A 640 655, for example). Commercially preferred products are, for example, derived from Teflon® 30 N of DuPont.

The suitable lubricant is selected from PEP-36 (bis(2,6-di-tert-butyl-4-methyl phenyl) pentaerythritol diphosphate) and the like.

The suitable light stabilizer includes one or combinations of benzotriazoles and benzophenones.

The suitable plasticizer is phthalate.

The suitable releasing agent includes metal stearates, alkyl stearates, pentaerythritol stearates, paraffin, lignite wax, and the like.

The suitable filler includes titanium dioxide, talc powder, mica and barium sulfate.

The suitable colorant includes various pigments, and dyes.

A preparation method of the above-described polycarbonate composition includes the following steps:

(1) formulating a compound containing a transition element and a phenyl siloxane into a phenyl siloxane solution of a mass fraction of 0.15 ppm-600 ppm; wherein the transition element is selected from Fe and/or Mn;

(2) blending the phenyl siloxane solution and a polycarbonate in a high-speed mixer to obtain a pretreated polycarbonate;

(3) after weighing the pretreated polycarbonate, a graft copolymer prepared from an alkaline earth metal salt by using an emulsion polymerization method, a fire retardant, and other aids in proportion, blending by the high-speed mixer or a mixer, extruding, cooling by means of water, and pelletizing to obtain a columnar particulate polycarbonate composition; wherein the alkaline earth metal is selected from Mg and/or Ca.

Because the polycarbonate composition of the present invention has an excellent long-term heat stability and weathering property, no appearance defects and excellent mechanical property, the polycarbonate composition of the present invention can be used for outdoor and indoor application fields, for example shell parts of various types and sizes, household appliances such as a TV set, a printer, a modem shell, and a display shell, or automobile parts for outdoor use, an enclosure or cover in a building field, and a housing and a frame for an electrical appliance.

Compared with the prior art, the present invention has the following advantageous effects:

according to the present invention, a long-term thermal-oxidative aging property and a weathering property of the polycarbonate composition can be significantly improved when a total compounding amount of a transition element and an alkaline earth metal, which are added in a polycarbonate composition formula, based on a total weight of the polycarbonate composition does not exceed 600 ppm and a compounding molar ratio of the transition element to the alkaline earth metal is adjusted to 0.1-1; and the polycarbonate composition is particularly suitable for occasions with relatively high requirements for an operating environment.

### DETAILED DESCRIPTION OF THE INVENTION

The present invention will be further described below by detailed embodiments, the following examples are preferred embodiments of the present invention, but the embodiments of the present invention are not limited by the following examples.

Testing standards or methods of various properties:

a testing method of a content of a transition metal: ICP-MS standard mixture method;

a testing method of a content of an alkaline earth metal: ICP-MS standard mixture method;

a determining method of a change in color difference in a UV aging property (150 h): ISO4982 color difference contrast;

a determining method of a 150° C. impact property retention rate (0 h, 150 h): ISO 180, energy 2.75 J;

a determining method of a glossiness: in accordance with GB/T 1743-1979, testing the glossiness of a standard color plate by using a glossiness testing meter, and selecting a reading at an angle of 85°;

a polycarbonate used in the present invention comprises:

a component a-1: PC 1300-10 (LG, Korea);

a component a-2: PC 1225 (Teijin, Japan);

a graft copolymer used in the present invention comprises:

a component b-1: ABS1 Emulsion method 757 (Chi Mei, Taiwan);

a component b-2: ABS2 Bulk method 8391 (Gaoqiao, Shanghai);

a component b-3: MBS EM500 (LG, Korea);

a transition element used in the present invention comprises:

Fe: Iron & Steel Research Institute, a standard solution;

Mn: Iron & Steel Research Institute, a standard solution;

an alkaline earth metal used in the present invention comprises:

Mg: Iron & Steel Research Institute, a standard solution;

Ca: Iron & Steel Research Institute, a standard solution;

a fire retardant used in the present invention comprises:

a component c: BDP, bisphenol A-bis(diphenyl phosphate) (ADEKA);

other aids used in the present invention comprises:

a component d-1: AO1076: n-octadecyl β-(3,5-di-tert-butyl-4-hydroxy phenyl) propionate CAS NO.: [2082-79-3]), as an antioxidant;

a component d-2: PEP-36 (bis(2,6-di-tert-butyl-4-methyl phenyl) pentaerythritol diphosphate), as a lubricant;

a component d-3: PTFE (polytetrafluoroethylene), as an anti-dripping agent.

### EXAMPLES 1 -15 and COMPARATIVE EXAMPLES 1-9

### Preparation of a Polycarbonate Composition

Formulating a compound containing a transition element and a phenyl siloxane into a phenyl siloxane solution of a mass fraction of 0.15 ppm-600 ppm, wherein the transition element is selected from Fe and/or Mn; blending the phenyl siloxane solution and a polycarbonate in a high-speed mixer to obtain a pretreated polycarbonate; after weighing the pretreated polycarbonate, a graft copolymer prepared from an alkaline earth metal salt by using an emulsion polymerization method , a fire retardant, and other aids in proportion in accordance with a formula in Table 1, blending by the high-speed mixer or a mixer, extruding, cooling by means of water, and pelletizing to obtain a columnar particulate polycarbonate composition; wherein the alkaline earth metal is selected from Mg and/or Ca; the 150° C. impact property retention rate (0 h, 150 h) and the change in the color difference in the UV aging property (150 h) of the polycarbonate composition were tested, and the data were listed in Table 1.

TABLE 1
Specific Proportion (parts by weight) and Other Property Testing Results in Examples1-15 and Comparative Exmaples1-9

| | Ex- | Ex- | Ex- | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|---|
| | am- | am- | am- | am- | am- | am- | am- | am- | am- | am- | am- | am- | am- | am- | am- |
| | ple 1 | ple 2 | ple 3 | ple 4 | ple 5 | ple 6 | ple 7 | ple 8 | ple 9 | ple 10 | ple 11 | ple 12 | ple 13 | ple 14 | ple 15 |
| component | 30 | 64 | 80 | | | 80 | 30 | | | | | 80 | 30 | | |
| a-1 | | | | | | | | | | | | | | | |
| component | | | | 30 | 64 | | | 64 | 80 | 30 | 64 | | | 64 | 80 |
| a-2 | | | | | | | | | | | | | | | |
| component | 50 | | 8 | | | | 50 | | 8 | | | | 50 | | 8 |
| b-1 | | | | | | | | | | | | | | | |
| component | | | | 50 | | 8 | | | | 50 | | 8 | | | |
| b-2 | | | | | | | | | | | | | | | |
| component | | 20 | | | 20 | | | 20 | | | 20 | | | 20 | |
| b-3 | | | | | | | | | | | | | | | |
| component | 19 | 15 | 11 | 19 | 15 | 11 | 19 | 15 | 11 | 19 | 15 | 11 | 19 | 15 | 11 |
| c | | | | | | | | | | | | | | | |
| component | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| d-1 | | | | | | | | | | | | | | | |
| component | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| d-2 | | | | | | | | | | | | | | | |
| component | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| d-3 | | | | | | | | | | | | | | | |
| content of | 160 | 10 | 210 | 120 | 20 | 180 | 40 | 60 | 120 | 180 | 7 | 40 | 160 | 20 | 90 |
| transition | | | | | | | | | | | | | | | |
| element | | | | | | | | | | | | | | | |
| (ppm) | | | | | | | | | | | | | | | |
| content of | 400 | 20 | 350 | 300 | 40 | 300 | 100 | 120 | 200 | 180 | 63 | 200 | 200 | 50 | 150 |
| alkaline | | | | | | | | | | | | | | | |
| earth | | | | | | | | | | | | | | | |
| metal | | | | | | | | | | | | | | | |
| (ppm) | | | | | | | | | | | | | | | |
| 150° C. | 100 | 100 | 100 | 100 | 100 | 100 | 100 | 100 | 100 | 100 | 100 | 100 | 100 | 100 | 100% |
| impact | | | | | | | | | | | | | | | |
| property | | | | | | | | | | | | | | | |
| retention rate | | | | | | | | | | | | | | | |
| (0 h, %) | | | | | | | | | | | | | | | |
| 150° C. | 65 | 77 | 85 | 68 | 79 | 87 | 69 | 81 | 90 | 69 | 68 | 80 | 82 | 92 | 91% |
| impact | | | | | | | | | | | | | | | |
| property | | | | | | | | | | | | | | | |
| retention rate | | | | | | | | | | | | | | | |
| (500 h, %) | | | | | | | | | | | | | | | |
| change in | 10 | 6 | 3 | 8 | 5 | 2 | 7 | 4 | 1 | 8 | 7 | 4 | 3 | 1 | 1 |
| color | | | | | | | | | | | | | | | |
| difference in | | | | | | | | | | | | | | | |
| UV aging | | | | | | | | | | | | | | | |
| property | | | | | | | | | | | | | | | |
| (500 h) | | | | | | | | | | | | | | | |
| glossiness | 84 | 92 | 96 | 87 | 94 | 98 | 89 | 96 | 101 | 87 | 88 | 93 | 95 | 103 | 102 |
| (85°) | | | | | | | | | | | | | | | |

| | Compar- | Compar- | Compar- | Compar- | Compar- | Compar- | Compar- | Compar- | Compar- |
|---|---|---|---|---|---|---|---|---|---|
| | ative | ative | ative | ative | ative | ative | ative | ative | ative |
| | Example 1 | Example 2 | Example 3 | Example 4 | Example 5 | Example 6 | Example 7 | Example 8 | Example 9 |
| component | 30 | 64 | 80 | | | 80 | 30 | | |
| a-1 | | | | | | | | | |
| component | | | | 30 | 64 | | | 64 | 80 |
| a-2 | | | | | | | | | |
| component | 50 | | 8 | | | | 50 | | 8 |
| b-1 | | | | | | | | | |
| component | | | | 50 | | 8 | | | |
| b-2 | | | | | | | | | |
| component | | 20 | | | 20 | | | 20 | |
| b-3 | | | | | | | | | |
| component | 19 | 15 | 11 | 19 | 15 | 11 | 19 | 15 | 11 |
| c | | | | | | | | | |
| component | 0.2 | 0.2 | 0.2 | 0.2 | 0.2 | 0.2 | 0.2 | 0.2 | 0.2 |
| d-1 | | | | | | | | | |
| component | 0.3 | 0.3 | 0.3 | 0.3 | 0.3 | 0.3 | 0.3 | 0.3 | 0.3 |
| d-2 | | | | | | | | | |
| component | 0.5 | 0.5 | 0.5 | 0.5 | 0.5 | 0.5 | 0.5 | 0.5 | 0.5 |
| d-3 | | | | | | | | | |
| content of | 0 | 30 | 300 | 200 | 240 | 240 | 100 | 120 | 320 |
| transition | | | | | | | | | |
| element | | | | | | | | | |
| (ppm) | | | | | | | | | |
| content of | 560 | 0 | 500 | 500 | 480 | 400 | 40 | 60 | 0 |
| alkaline | | | | | | | | | |
| earth | | | | | | | | | |
| metal | | | | | | | | | |
| (ppm) | | | | | | | | | |
| 150° C. | 100 | 100 | 100 | 100 | 100 | 100 | 100 | 100 | 100 |
| impact | | | | | | | | | |
| property | | | | | | | | | |
| retention rate | | | | | | | | | |
| (0 h, %) | | | | | | | | | |
| 150° C. | 30 | 44 | 12 | 23 | 32 | 21 | 27 | 15 | 33 |
| impact | | | | | | | | | |
| property | | | | | | | | | |
| retention rate | | | | | | | | | |
| (500 h, %) | | | | | | | | | |
| change in | 50 | 32 | 27 | 14 | 22 | 21 | 34 | 33 | 20 |
| color | | | | | | | | | |
| difference in | | | | | | | | | |
| UV aging | | | | | | | | | |
| property | | | | | | | | | |
| (500 h) | | | | | | | | | |
| glossiness | 60 | 55 | 47 | 46 | 52 | 45 | 49 | 33 | 50 |
| (85°) | | | | | | | | | |

It may be seen from a comparison of Examples with Comparative Examples in Table 1 that, a long-term thermal-oxidative aging property and a weathering property of the polycarbonate composition can be significantly improved when the total compounding amount of the transition element and the alkaline earth metal, which are added in a polycarbonate composition formula, based on the total weight of the polycarbonate composition is greater than or equal to 10 ppm and less than or equal to 600 ppm and the compounding molar ratio of the transition element to the alkaline earth metal is adjusted to 0.1-1; and the polycarbonate composition is particularly suitable for occasions with relatively high requirements for an operating environment.

What is claimed:

1. A polycarbonate composition, comprising the following components in parts by weight:
a. 30-80 parts of a polycarbonate;
b. 8-50 parts of a graft copolymer;
c. 5-25 parts of a fire retardant; and
d. 0-10 parts of other aids;
wherein a sum of parts by weight of the four components a, b, c, and d is 100.

2. The polycarbonate composition according to claim 1, comprising the following components in parts by weight:
a. 35-75 parts of the polycarbonate;
b. 8-35 parts of the graft copolymer;
c. 5-25 parts of the fire retardant; and
d. 0-10 parts of other aids;
wherein a sum of parts by weight of the four components a, b, c, and d is 100;
a total compounding amount of a transition element and an alkaline earth metal based on a total weight of said polycarbonate composition is greater than or equal to 10 ppm and less than or equal to 600 ppm, and a compounding molar ratio of the transition element to the alkaline earth metal is 0.1-1.

3. The polycarbonate composition according to claim 2, wherein the total compounding amount of the transition element and the alkaline earth metal based on a total weight of the polycarbonate composition is greater than or equal to 50 ppm and less than or equal to 500 ppm, preferably greater than or equal to 70 ppm and less than or equal to 400 ppm.

4. The polycarbonate composition according to claim 2, wherein said compounding molar ratio of the transition element to the alkaline earth metal is 0.2-0.8; preferably 0.3-0.6.

5. The polycarbonate composition according to claim 2, wherein said transition element is selected from Fe and/or Mn; and said alkaline earth metal is selected from Mg and/or Ca.

6. The polycarbonate composition according to claim 1, wherein said polycarbonate is selected from one or more of an aromatic polycarbonate, an aliphatic polycarbonate, an aromatic-aliphatic polycarbonate, a branched polycarbonate, and a siloxane copolycarbonate, preferably the aromatic polycarbonate.

7. The polycarbonate composition according to claim 6, wherein said aromatic polycarbonate is an aromatic polycarbonate with a viscosity-average molecular weight of 13000-40000, preferably an aromatic polycarbonate with a viscosity-average molecular weight of 16000-28000.

8. The polycarbonate composition according to claim 1, wherein said graft copolymer is selected from one or more of a graft copolymer prepared from an alkaline earth metal salt by using an emulsion polymerization method, a graft copolymer prepared from an alkaline earth metal salt by using a bulk polymerization method, and a graft copolymer prepared from an alkaline earth metal salt by using a bulk-suspension polymerization method, preferably the graft copolymer prepared from the alkaline earth metal salt by using the emulsion polymerization method.

9. The polycarbonate composition according to claim 1, wherein said graft copolymer is selected from the following graft copolymers with b.1 on b.2 in parts by weight:
b.1 5-95 parts of a mixture of b.1.1 and b.1.2:
b.1.1 50-95 parts of one or more of styrene, styrene derivatives such as α-methyl styrene, p-benzyl styrene, and divinyl styrene, a C1-C8 alkyl methacrylate, a C1-C8 alkyl acrylate, dimethyl siloxane, phenyl siloxane, and multi-alkyl siloxane;
b.1.2 5-50 parts of one or more of acrylonitrile, methyl acrylonitrile, a C1-C8 alkyl methacrylate, and a C1-C8 alkyl acrylate;
b.2 5-95 parts of one or more of polybutadiene, polyisoprene, a styrene-butadiene random copolymer and block copolymer, an acrylonitrile-butadiene random copolymer and block copolymer, a polybutadiene and polyisoprene copolymer, an ethylene and α-alkene copolymer, an ethylene and α-unsaturated carboxylate copolymer, an ethylene-propene-nonconjugated diene terpolymer, an acryloyl rubber, and an organic siloxane rubber.

10. The polycarbonate composition according to claim 9, wherein said graft copolymer s selected from one or more of an acrylonitrile-styrene copolymer AS, an acrylonitrile-butadiene-styrene graft copolymer ABS, a methyl methacrylate-acrylonitrile-butadiene-styrene copolymer MABS, an acrylonitrile-styrene-propenoic acid terpolymer ASA, and a methyl methacrylate-butadiene-styrene graft copolymer MBS, preferably the acrylonitrile-butadiene-styrene graft copolymer ABS; wherein a particle diameter of said MBS is preferably 0.1 μm-0.5 μm, a particle diameter of said ABS in a bulk polymerization method is preferably 0.1 μm-2 μm, and a particle diameter of said ABS in a emulsion polymerization method is preferably 0.05 μm-0.2 μm.

11. The polycarbonate composition according to claim 1, wherein said fire retardant is selected from one or more of a halogen-based fire retardant or a halogen-free fire retardant, preferably the halogen-free fire retardant; said halogen-based fire retardant is selected from one or more of a brominated polystyrene, a brominated polyphenyl ether, a brominated bisphenol A type epoxy resin, a brominated styrene-maleic anhydride copolymer, a brominated epoxy resin, a brominated phenoxy resin, decabromodiphenyl oxide, decabromodiphenyl, a brominated polycarbonate, perbromotricyclopentadecane or a brominated aromatic crosslinked polymer, preferably the brominated polystyrene; said halogen-free fire retardant is selected from one or more of a nitrogen-containing fire retardant, a phosphorus-containing tire retardant, and a nitrogen- and phosphorus-containing fire retardant, preferably the phosphorus-containing fire retardant.

12. The polycarbonate composition according to claim 11, wherein said phosphorus-containing fire retardant is selected from one or more of diphenyl phosphate, tritolyl phosphate, tolyl diphenyl phosphate, trixylyl phosphate, tri(2,4,6-trimethyl phenyl) phosphate, tri(2,4-di-tert-butyl phenyl) phosphate, tri(2,6-di-tert-butyl phenyl) phosphate, resorcinol bis(diphenyl phosphate), hydroquinone bis(diphenyl phosphate), bisphenol A-bis(diphenyl phosphate), resorcinol bis(2,6-di-tert-butyl phenyl phosphate), and hydroquinone bis(2,6-dimethyl phenyl phosphate).

13. The polycarbonate composition according to claim 1, wherein other aids of said component d is selected from one or more of a heat stabilizer, an antioxidant, an anti-dripping agent, a lubricant, a releasing agent, a light stabilizer, a plasticizer, a filler, and a colorant.

14. A preparation method of the polycarbonate composition according to claim 1, comprising the following steps:
(1) formulating a compound containing a transition element and a phenyl siloxane into a phenyl siloxane solution of a mass fraction of 0.15 ppm-600 ppm, wherein said transition element is selected from Fe and/or Mn;
(2) blending said phenyl siloxane solution and a polycarbonate in a high-speed mixer to obtain a pretreated polycarbonate; and
(3) after weighing the pretreated polycarbonate, a graft copolymer prepared from an alkaline earth metal salt by using an emulsion polymerization method, a fire retardant, and other aids in proportion, blending by the high-speed mixer or a mixer, extruding, cooling by means of water, and pelletizing to obtain a columnar particulate polycarbonate composition, wherein said alkaline earth metal is selected from Mg and/or Ca.

15. The polycarbonate composition according to claim 3, wherein said transition element is selected from Fe and/or Mn; and said alkaline earth metal is selected from Mg and/or Ca.

16. The polycarbonate composition according to claim 4, wherein said transition element is selected from Fe and/or Mn; and said alkaline earth metal is selected from Mg and/or Ca.

17. The polycarbonate composition according to claim 2, wherein said polycarbonate is selected from one or more of an aromatic polycarbonate, an aliphatic polycarbonate, an aromatic-aliphatic polycarbonate, a branched polycarbonate, and a siloxane copolycarbonate, preferably the aromatic polycarbonate.

18. The polycarbonate composition according to claim 2, wherein said graft copolymer is selected from one or more of a graft copolymer prepared from an alkaline earth metal salt by using an emulsion polymerization method, a graft copolymer prepared from an alkaline earth metal salt by using a bulk polymerization method, and a graft copolymer prepared from an alkaline earth metal salt by using a bulk-suspension polymerization method, preferably the graft copolymer prepared from the alkaline earth metal salt by using the emulsion polymerization method.

19. The polycarbonate composition according to claim 2, wherein said graft copolymer is selected from the following graft copolymers with b.1 on b.2 in parts by weight:
b.1 5-95 parts of a mixture of b.1.1 and b.1.2:
b.1.1 50-95 parts of one or more of styrene, styrene derivatives such as α-methyl styrene, p-benzyl styrene, and divinyl styrene, a C1-C8 alkyl methacrylate, a C1-C8 alkyl acrylate, dimethyl siloxane, phenyl siloxane, and multi-alkyl siloxane;
b.1.2 5-50 parts of one or more of acrylonitrile, methyl acrylonitrile, a C1-C8 alkyl methacrylate, and a C1-C8 alkyl acrylate;
b.2 5-95 parts of one or more of polybutadiene, polyisoprene, a styrene-butadiene random copolymer and block copolymer, an acrylonitrile-butadiene random copolymer and block copolymer, a polybutadiene and polyisoprene copolymer, an ethylene and α-alkene copolymer, an ethylene and α-unsaturated carboxylate copolymer, an ethylene-propene-nonconjugated diene terpolymer, an acryloyl rubber, and an organic siloxane rubber.

20. The polycarbonate composition according to claim 2, wherein said fire retardant is selected from one or more of a halogen-based fire retardant or a halogen-free fire retardant, preferably the halogen-free fire retardant; said halogen-based fire retardant is selected from one or more of a brominated polystyrene, a brominated polyphenyl ether, a brominated bisphenol A type epoxy resin, a brominated styrene-maleic anhydride copolymer, a brominated epoxy resin, a brominated phenoxy resin, decabromodiphenyl oxide, decabromodiphenyl, a brominated polycarbonate, perbromotricyclopentadecane or a brominated aromatic crosslinked polymer, preferably the brominated polystyrene; said halogen-free fire retardant is selected from one or more of a nitrogen-containing fire retardant, a phosphorus-containing fire retardant, and a nitrogen- and phosphorus-containing fire retardant, preferably the phosphorus-containing fire retardant.
